(19) United States
(12) Patent Application Publication
(10) Pub. No.: US 2024/0068880 A1
(43) Pub. Date: Feb. 29, 2024

(54) TEMPERATURE SENSOR USING EXTERNAL DIODE

(71) Applicant: Texas Instruments Incorporated, Dallas, TX (US)

(72) Inventors: Santhosh Kumar Srinivasan, BENGALURU (IN); Robert A. Neidorff, BEDFORD, NH (US); Ramakrishna Ankamreddi, BANGALORE (IN); Sravya Kanneganti, Dallas, TX (US); Padmanabh S. Prabhu, Bangalore (IN)

(21) Appl. No.: 17/897,549

(22) Filed: Aug. 29, 2022

(51) Int. Cl. G01K 7/01

(52) U.S. Cl. CPC G01K 7/01

(57) ABSTRACT

Described embodiments include a circuit for temperature sensing having a first current source coupled to a diode input terminal. The first current source provides a first current at a first current output. A second current source provides a second current at a second current output. The second current is larger than the first current. A first switch is coupled between the second current source output and the diode input terminal. A capacitor is coupled between the diode input terminal and a temperature output terminal. A second switch is coupled between the temperature output terminal and a ground terminal. The temperature output terminal provides a temperature signal having a voltage that is proportional to a temperature of a component.

### TECHNICAL FIELD

This description relates to temperature sensing using an external diode, and more particularly to sensing the temperature of an external component, such as a power circuit drive transistor, using a temperature sensing diode.

### BACKGROUND

Accurate temperature sensing can be important in applications where field effect transistors (FETs) carry currents up to hundreds of amps, such as in hybrid automobiles and computer servers. A large current through a FET causes the temperature of the FET to rise significantly. If the temperature of a FET is not monitored and controlled, it may exceed the safe operational temperature of the FET, possibly resulting in damage to or destruction of the FET.

Temperature sensing can be accomplished using a diode or a transistor configured as a diode. In some applications, the temperature sensor is located in a drive controller circuit. However, if the drive controller circuit is located on the opposite side of the printed circuit board from the FET, the accuracy of the temperature measurement may be compromised. Positioning a temperature sensing diode proximate to the FET improves the accuracy of the temperature measurement.

### SUMMARY

In a first example, a first current source having a first current output is coupled to a diode input terminal. The first current source is configured to provide a first current at the first current output. A second current source is configured to provide a second current at a second current output. The second current is larger than the first current. A first switch is coupled between the second current source and the diode input terminal.

A capacitor is coupled between the diode input terminal and a temperature output terminal. A second switch is coupled between the temperature output terminal and a ground terminal. The second switch is configured to provide a voltage signal to the temperature output terminal, in which the voltage signal indicates a temperature.

In a second example, a method for sensing the temperature of a component includes providing a first current to a diode input terminal by closing a first switch that is coupled between a first current source and the diode input terminal. A second current is provided to the diode input terminal by opening the first switch and closing a second switch that is coupled between a second current source and the diode input terminal.

A third switch is opened and closed synchronously with the opening and closing of the first switch. The third switch is coupled between a temperature output terminal and a ground terminal. A capacitor is coupled between the diode input terminal and the temperature output terminal, and a voltage signal that is indicative of a temperature of a component is provided at the temperature output terminal.

### BRIEF DESCRIPTION OF THE DRAWINGS

FIG. 1 shows a block diagram of an example temperature sensing circuit using an external diode.

FIG. 2 shows an example truth table of the controller logic describing the conditions for asserting a temperature fault indication.

FIG. 3 shows an example graph of the controller logic versus temperature for the temperature fault indication signal.

FIG. 4 shows a block diagram for an example ΔV_{be} sampling circuit.

FIG. 5 shows a schematic for an example temperature sensor using a ΔV_{be} sampling circuit.

FIG. 6 shows a block diagram for an example end equipment application using a temperature sensor circuit.

### DETAILED DESCRIPTION

In this description, the same reference numbers depict same or similar (by function and/or structure) features. The drawings are not necessarily drawn to scale.

The embodiments described herein are directed to temperature sensing in high power field effect transistor (FET) drive circuits. In circuits where a FET may carry hundreds of amps of current, the temperature of the FET can rise significantly, possibly leading to damage to the FET if proper protection for the FET is not put in place. Proper protection for the FET includes sensing the temperature of the FET, and shutting the FET off if a temperature limit is exceeded. In these applications, a FET that carries high current is usually external to the circuit controlling the drive of the FET. In some applications, the FET may be placed a considerable distance from the FET controller circuit, even possibly on the opposite side of the board from the controller circuit.

In this case, the temperature of the FET and the temperature of the controller circuit may differ significantly, making accurate measurement of the FET temperature more challenging. Accurate measurement of the FET temperature is important because the more accurate the temperature measurement is, the closer to the FET maximum temperature the controller can go before shutting down the FET to protect it. Therefore, increasing the accuracy of the temperature sensing increases the operating temperature range for the FET.

The majority of the heat in a FET is near the drain of the FET. So, the closer the temperature sensor is placed to the drain terminal of the FET, the more accurate the measurement of the FET temperature. A FET may be specified to withstand a transient of 100 V across the FET, from the drain to the source, because a transient of the 48V battery can reach 100 V in an automotive application.

In many cases, the controller circuit may not be located very close to the FET. For this reason, an external temperature sensor located proximate to the drain of the FET is used to more accurately report the FET temperature to the controller. A discrete npn transistor configured as a diode can be used for the temperature sensor. However, a pnp transistor or a diode may be used in place of the npn transistor for temperature sensing.

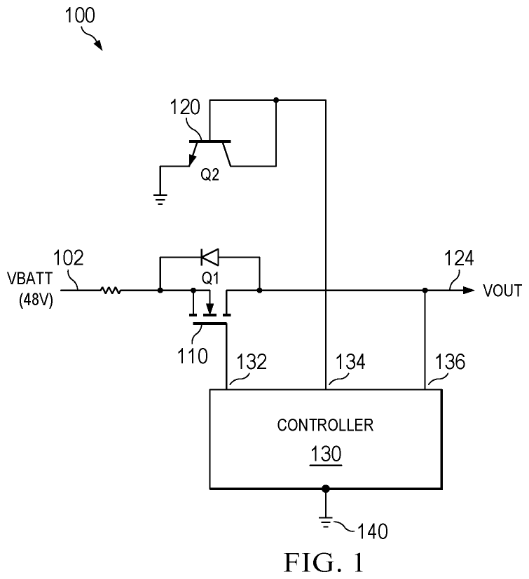

FIG. 1 shows a block diagram of an example temperature sensing circuit 100 using an external diode. Transistor 110 is a FET Q1 that provides drive current for a voltage regulator circuit (not shown). Transistor 110 is external to controller 130, which has a terminal 132 coupled to the gate of transistor 110. Controller 130 controls turning transistor 110 on and off. The drain of transistor 110 is coupled to a supply voltage terminal 102. The current at supply voltage terminal 102 can be supplied from a battery or from some other DC power source, and the voltage at terminal 102 may be at 48V or at some other voltage.

The source of transistor 110 is coupled to an output voltage terminal VOUT 124, and to an input terminal 136 of controller 130, which monitors the voltage at VOUT 124. Transistor 120 is a npn transistor Q2. The emitter of transistor 120 is coupled to ground. The base of transistor 120 is connected to the collector of transistor 120, which is also coupled to controller 130 at terminal 134. This configuration effectively makes transistor 120 a diode coupled between terminal 134 of controller 130 and ground. Transistor 120 is placed near the drive FET Q1 110, and in particular near the drain terminal of Q1 110. Transistor 120 is a remote temperature sensor for transistor 110.

The temperature of transistor 110 is sensed, and that temperature is reported to controller 130 by transistor 120 at terminal 134. If the reported temperature of transistor 110 exceeds a target temperature threshold, controller 130 turns transistor 110 off by controlling its gate with a signal at terminal 132, and a temperature fault indication is asserted. Hysteresis is built into controller 130 whereby after a temperature fault indication is asserted, the reported temperature of transistor 110 must fall below a lower threshold before the temperature fault indication is removed.

Controller 130 has an internal temperature sensor to sense the temperature at the controller. The temperature at controller 130 may differ significantly from the temperature of transistor 110, depending on how far controller 130 is from transistor 110. However, the internal temperature sensor of controller 130 may not use the same temperature sensing method as for transistor 110 because the necessity for accurate temperature measurement of controller 130 is not as great as for transistor 110. Further, because the internal temperature sensor for controller 130 is fabricated from the same process as controller 130, temperature characteristics will be more repeatable. In contrast, the external temperature sensor, transistor 120 is user-supplied, so the diode may be from different manufacturers in different systems, and may have wider process variations over temperature.

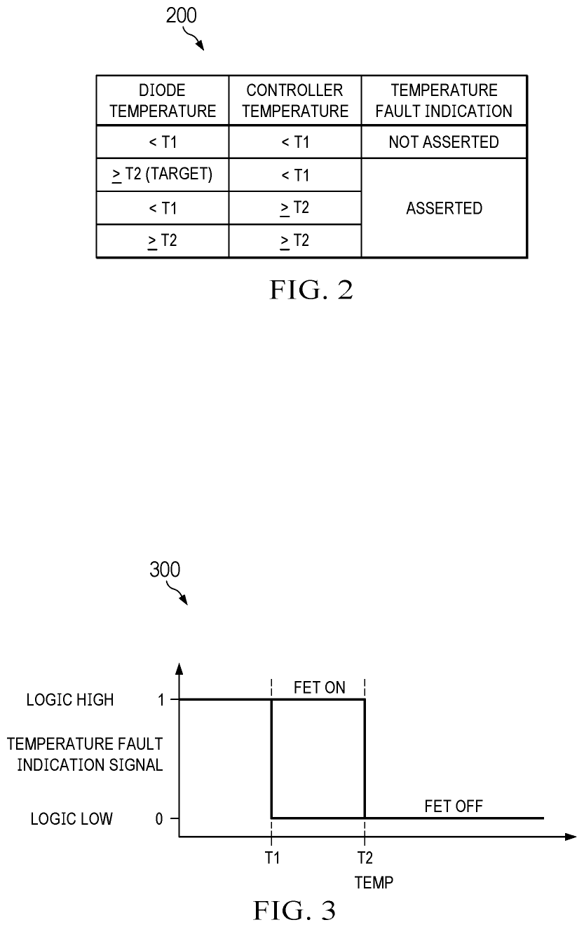

FIG. 2 shows a truth table 200 of the controller logic determining the conditions for controller 130 to assert a temperature fault indication. Temperature T1 is a first temperature threshold and represents a minimum dropout temperature, a temperature at which transistor 110 can operate without damage or degradation of reliability. Temperature T2 is a second temperature threshold, higher than the first temperature threshold T1, and is the target temperature. Temperature T2 is the temperature at which transistor 110 will be turned off by controller 130 and a temperature fault indication will be asserted.

After transistor 110 is turned off, its temperature will decrease. However, transistor 110 will not be turned on again when it reaches temperature T2 on the way back down. Controller 130 has built-in hysteresis, so the temperature continues to fall with transistor 110 turned off until the temperature of transistor 110 reaches T1. As it cools, transistor 110 will be turned on again after it reaches temperature T1. In some cases, the temperature difference between T1 and T2 is equal to an expected accuracy of the temperature sense measurement from transistor 120. In one example, temperature T1 is set at 150° C. and temperature T2 is set at 160° C.

If the temperature sense measurement from transistor 120 and the controller temperature are both less than temperature T1, the temperature fault is not asserted. If the temperature sense measurement from transistor 120 is greater than or equal to the target temperature T2, and the controller temperature is less than temperature T1, a temperature fault indication is asserted by controller 130. If the controller temperature is greater than or equal to the target temperature T2, and the temperature sense measurement from transistor 120 is less than temperature T1, a temperature fault indication is asserted because the controller heating may be due to FETs located near the controller reaching temperature T2. If both the temperature sense measurement from transistor 120 and the controller temperature are greater than or equal to temperature T2, then a temperature fault indication is asserted.

FIG. 3 shows a graph 300 of the controller logic versus temperature for the temperature fault indication signal. The X axis of graph 300 represents the temperature of the FET as sensed by the external diode. The Y-axis represents the temperature fault indication signal. In this example, the temperature fault indication signal is active low. The default condition for the temperature fault indication signal is to not be asserted, or a logic high in this instance. However, in other instances, the temperature fault indication signal can be active high, in which case the default condition would be a logic low.

The temperature fault indication signal remains unasserted (high) as long as the temperature of the FET and the controller remain below T2. If the temperature of the FET reaches T2, the temperature fault indication signal goes low and the FET is turned off. With the FET turned off, the temperature of the FET will decrease. Hysteresis is added, so the temperature fault indication signal will not immediately go high again when the temperature falls below T2. After initially getting to a temperature of T2. Due to hysteresis, the temperature of the FET must drop below T1 before the FET will be turned on. When the FET temperature falls to T1, the temperature fault indication will be cleared and the FET will be turned on again.

At least first and second methods exist for using a diode to sense temperature. The first method, the V_{be} method, is to apply a current to a diode and measure the voltage drop across the diode. A diode will have a higher voltage drop at colder temperatures, and will have a lower voltage drop at higher temperatures. The relationship between temperature and the voltage drop across a diode is given by equation (1),

$$Vbe = \frac{kT}{q} ln ( \frac{i}{io} ) \qquad ( 1 )$$

where Vbe is the forward voltage of the diode, or the voltage from base-to-emitter of a bipolar junction transistor configured as a diode, K is Boltzmann's constant, T is the temperature of the diode, q is the absolute value of electron charge, I is the current applied to the diode, and iₒ is the diode saturation current. The diode saturation current iₒ is a characteristic of the diode, and can vary from one diode to another, and can also vary with temperature. The variation of iₒ from one diode to another decreases the accuracy of the V_{be} method as a temperature sensor.

The second method is the ΔV_{be} method, which is more accurate than the V_{be} method. The ΔV_{be} method includes applying a first current to a diode followed by a second current, and measuring the difference in voltage drop across the diode between the first current and the second current. The ΔV_{be} method is more accurate than the V_{be} method because the contribution of the diode saturation current iₒ is cancelled out by subtracting the first measurement from the second measurement in the ΔV_{be} method. The relationship between temperature and ΔV_{be} is given by equation (2),

$$Δ Vbe = \frac{kT}{q} ln ( \frac{i 2}{i 1} ) \qquad ( 2 )$$

where ΔV_{be} is the difference in voltage drop across the diode applying the second current and the voltage drop across the diode applying the first current, i₁ is the first current applied to the diode, and i₂ is the second current applied to the diode.

The value of ΔV_{BE} depends only upon the temperature, and is independent of process or device parameters. An advantage that the ΔV_{be} method brings over the V_{be} method for temperature sensing is that it has no dependence on the diode saturation current iₒ, so: (a) the inherent inaccuracy due to the variability of iₒ is subtracted out, and (b) it has no need to calibrate out the differences in process and device parameters from one diode to another, so virtually any diode or diode-connected transistor will work with the ΔV_{be} method.

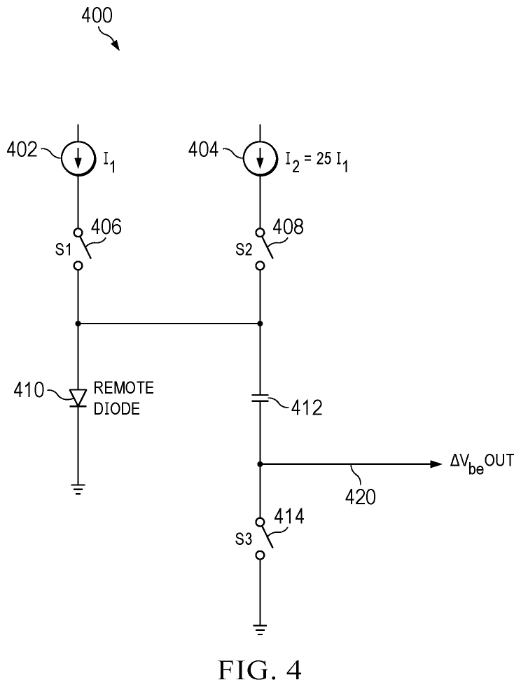

FIG. 4 shows a block diagram for an example ΔV_{be} sampling circuit 400. Diode 410 is a remote temperature-sensing diode that is located proximate the drain of a drive FET (not shown). The cathode of remote diode 410 is coupled to ground. A current source 402 provides a first current I₁. Switch S1 406 is coupled between the first current source 402 and the anode of remote diode 410. A second current source 404 provides a second current I₂. In some cases, current I₂ is much larger than current I₁ in order to improve accuracy of the temperature measurement by creating a larger ΔV_{be} voltage. In one example, I₂=25*I₁.

Switch S2 408 is coupled between current source 404 and the anode of remote diode 410. Capacitor 412 is a sampling capacitor coupled between the anode of remote diode 410 and an output terminal 420 which provides a ΔV_{be} voltage output that can be provided to a controller circuit for further processing. Switch S3 414 is coupled between capacitor 412 and ground.

First, switches S1 406 and S3 414 are closed, and current source 402 provides current I₁ to remote diode 410. The current I₁ is also provided to capacitor 412, charging capacitor 412 to a first voltage that is equal to the V_{be} of remote diode 410 with the current I₁ (VBE1). Then, switches S1 406 and S3 414 are opened, leaving capacitor 412 at a voltage equal VBE1, and the voltage at output terminal 420 is left floating.

Switch S2 408 is then closed, providing current I₂ from current source 404 to the anode of remote diode 410. This produces a second voltage on capacitor 412 that is equal to the V_{be} of remote diode 410 with the current I₂ (VBE2). Capacitor 412 will not allow the change in voltage across it. Because the bottom plate of capacitor 412 is floating and capacitor 412 was previously charged to a voltage of VBE1, the voltage at terminal 420 will be equal to (VBE2−VBE1), which is ΔV_{be}.

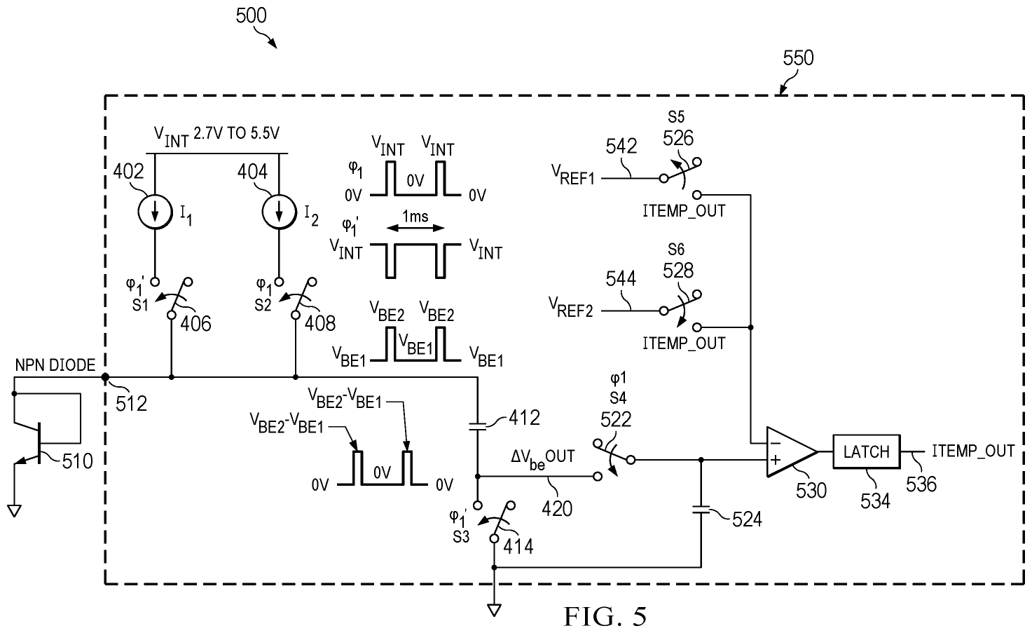

FIG. 5 shows a schematic for an example temperature sensor 500 using a ΔV_{be} sampling circuit. Temperature sensor 500 includes an external diode 510 and controller 550. External diode 510 is located proximate the drain of an external drive FET (not shown), and is coupled between ground and a connection terminal 512 to controller 550. A current source 402 provides a first current I₁. Switch S1 406 is coupled between current source 402 and external diode 510. A second current source 404 provides a second current I₂. In some cases, current I₂ is much larger than current I₁ in order to improve the accuracy of the temperature measurement by creating a larger ΔV_{be} voltage.

Switch S2 408 is coupled between current source 404 and external diode 510. Capacitor 412 is coupled between external diode 510 and an output terminal 420 that provides a ΔV_{be} voltage output. The voltage at terminal 420 is proportional to the temperature of external diode 510. Switch S3 414 is coupled between capacitor 412 and ground. Switch S4 522 is coupled between output terminal 420 and a first terminal of a capacitor 524. A second terminal of capacitor 524 is coupled to ground.

Comparator 530 has first and second inputs and an output. The first input is coupled to switch S4 522 and to the first terminal of capacitor 524. The output of comparator 530 is coupled to an input of a latch 534. An output of latch 534 is coupled to an ITEMP_OUT terminal 536. A first reference voltage terminal 542 provides a first reference voltage V_{REF1}, which represents a first temperature threshold. A second reference voltage terminal 544 provides a second reference voltage V_{REF2}, which represents a second temperature threshold. The second reference voltage V_{REF2} is at a lower voltage than the first reference voltage V_{REF1}, which allows a hysteresis in the output of comparator 530.

Switch S5 526 is coupled between the first reference voltage terminal 542 and the second input to comparator 530, and is controlled by a signal from the ITEMP_OUT terminal 536. Switch S6 528 is coupled between the second reference voltage terminal 544 and the second input to comparator 530, and is controlled by the signal from the ITEMP_OUT terminal 536. The signal from the ITEMP_OUT terminal 536 controls switches S5 526 and S6 528 in opposite directions. When the ITEMP_OUT signal is asserted, switch S5 526 is opened and switch S6 528 is closed.

A ΔV_{be} voltage representing the temperature of external diode 510 is sampled and provided at the output terminal 420. The ΔV_{be} voltage is compared to the first reference voltage, which represents an upper threshold temperature using comparator 530. If the ΔV_{be} voltage exceeds the first reference voltage, a temperature fault indication is latched at the ITEMP_OUT terminal 536. Hysteresis is built into the circuit, so the temperature fault indication is not cleared until the ΔV_{be} voltage drops below the second reference voltage.

The ΔV_{be} voltage is sampled by closing switches S1 406 and S3 414. Current source 402 provides current I₁ to external diode 510. The current I₁ is also provided to capacitor 412, charging capacitor 412 to a first voltage that is equal to the V_{be} of external diode 510 with current I₁ (VBE1). Then, switches S1 406 and S3 414 are opened, leaving capacitor 412 at a voltage equal to VBE1, and the voltage at output terminal 420 is left floating.

Switch S2 408 is then closed, providing current I₂ from current source 404 to external diode 510. This produces a second voltage on capacitor 412 that is equal to the V_{be} of external diode 510 with current I₂ (VBE2). Capacitor 412 will not allow the change in voltage across it. Because the bottom plate of capacitor 412 is floating and capacitor 412 was previously charged to a voltage of VBE1, the voltage at terminal 420 will be equal to (VBE2−VBE1), which is ΔV_{be}. This ΔV_{be} voltage is available at output terminal 420, and is stored on capacitor 524 when switch S4 522 is closed.

The ΔV_{be} voltage at terminal 420 is directly proportional and corresponds to a temperature of external diode 510. The first reference voltage V_{REF1} corresponds to a temperature at which the temperature fault indication should be asserted and the external FET should be shut down. The second reference voltage V_{REF2} corresponds to a temperature at which it is acceptable to clear the temperature fault indication and turn the external FET on again. To provide hysteresis, V_{REF2} is lower than V_{REF1}.

In normal operation without temperature fault indication, switch S5 526 is closed, providing the first reference voltage V_{REF1} to the second input of comparator 530. Switch S4 522 closes, providing the ΔV_{be} voltage to the first input of comparator 530. The output of comparator 530 remains low and no temperature fault indication is asserted as long as the ΔV_{be} voltage remains lower than V_{REF1}. If the temperature of external diode 510 goes above the upper threshold temperature, the ΔV_{be} voltage will be higher than V_{REF1} and the output of comparator 530 will go high. The output of comparator 530 is provided to the input of latch 534. Latch 534 will assert the temperature fault signal by providing a high signal at ITEMP_OUT 536. This temperature fault signal can be provided to a gate drive circuit (not shown) to shut down the external FET.

When the ITEMP_OUT signal goes high, switch S5 526 is opened and switch S6 528 is closed. The second reference voltage V_{REF2} is now provided to the second input of comparator 530. The output of comparator 530 will remain high until the ΔV_{be} voltage falls below the voltage V_{REF2}, at which time the output of comparator 530 will go low. When the output of comparator 530 goes low, latch 534 will clear the temperature fault signal by providing a low signal at ITEMP_OUT 536. This will cause switches S5 526 to close and switch S6 528 to open, and the first reference voltage V_{REF1} will be provided to the second input of comparator 530. Other methods of adding hysteresis to comparator 530 may be used in temperature sensor 500.

The duty cycles for current sources I1 and I2 do not necessarily have to be equal. In at least one example, switch S1 406 is turned on for 1 msec with switch S2 408, then switch S1 is turned off and switch S2 is turned on for 100 usec. This cycle then repeats. In this case, the smaller current, I1, flows for 90% of each cycle and the larger current, I2, flows for 10% of each cycle. Having the larger current flow for a smaller portion of each cycle provides a power savings.

In another example, switch S1 406 is omitted and the output of current source 402 is coupled directly to connection terminal 512. In this case, current I1 is always provided to external diode 510. With switch S2 408 open, external diode 510 will receive current I1, and with switch S2 closed, external diode 510 will receive current I1+I2. If current I2 is considerably larger than current I1, then the difference between I2 and I1+I2 is relatively small.

Temperature sensor 500 compares the temperature of external diode 510 to two threshold temperatures. However, additional temperature thresholds can be added to compare to the temperature of external diode 510. The additional thresholds are added by coupling additional switches in parallel with switches S5 526 and S6 528. Each of the additional switches are then coupled to a separate reference voltage that corresponds to a respective temperature. This can provide multiple temperature datapoints to other system components for further processing.

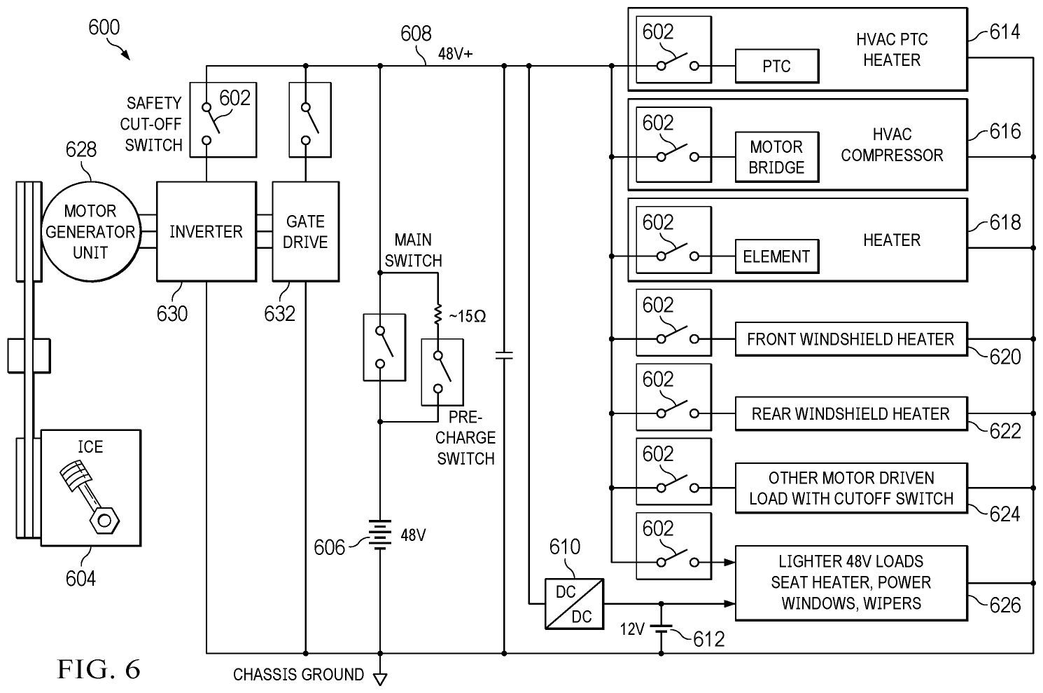

FIG. 6 shows a block diagram 600 for an example end equipment using a temperature sensor circuit, a mild hybrid automobile that is powered from both electricity and gasoline. The gasoline power is from an internal combustion engine (ICE) 604, and the electric power is from a 48V battery 606. The ICE powers a motor generator unit 628, which provides drive to the automobile and generates an AC voltage that is converted to a DC voltage that recharges the 48V battery 606. The motor generator unit 628 is coupled to inverter 630, which is an AC-to-DC and DC-to-AC bridge. The inverter 630 can be used to charge the 48V battery 606 or to drive the motor from the battery. A DC-to-DC buck converter 610 has an input coupled to a 48V bus 608, and has an output coupled to 12V battery 612.

A gate drive circuit 632 controls the FETs in the inverter 630. The inverter has numerous FETs to generate a three-phase drive for the motor. Several modules within the automobile have FETs being controlled by a controller circuit 602. These modules include a PTC heater 614, an air conditioner compressor 616, a heater 618, a front windshield heater 620 and a rear windshield heater 622. In each of these modules, the controller circuit that controls the external FET includes a temperature sensor circuit coupled to a remote temperature sensing diode that is located proximate the external FET.

In this description, “terminal,” “node,” “interconnection,” “lead” and “pin” are used interchangeably. Unless specifically stated to the contrary, these terms generally mean an interconnection between or a terminus of a device element, a circuit element, an integrated circuit, a device, or other electronics or semiconductor component.

In this description, the term “couple” may cover connections, communications or signal paths that enable a functional relationship consistent with this description. For example, if device A generates a signal to control device B to perform an action, then: (a) in a first example, device A is coupled to device B by direct connection; or (b) in a second example, device A is coupled to device B through intervening component C if intervening component C does not alter the functional relationship between device A and device B, so device B is controlled by device A via the control signal generated by device A.

In this description, “ground” includes a chassis ground, an Earth ground, a floating ground, a virtual ground, a digital ground, a common ground and/or any other form of ground connection applicable to, or suitable for, the teachings of this description.

In this description, even if operations are described in a particular order, some operations may be optional, and the operations are not necessarily required to be performed in that particular order to achieve specified results. In some examples, multitasking and parallel processing may be advantageous. Moreover, a separation of various system components in the embodiments described above does not necessarily require such separation in all embodiments.

Modifications are possible in the described embodiments, and other embodiments are possible, within the scope of the claims.

What is claimed is:

1. A circuit for temperature sensing, the circuit comprising:
a first current source having a first current output coupled to a diode input terminal, the first current source configured to provide a first current at the first current output;
a second current source having a second current output, the second current source configured to provide a second current at the second current output, in which the second current is larger than the first current;
a first switch coupled between the second current output and the diode input terminal;
a capacitor coupled between the diode input terminal and a temperature output terminal; and
a second switch coupled between the temperature output terminal and a ground terminal, the second switch configured to provide a voltage signal to the temperature output terminal, in which the voltage signal indicates a temperature.

2. The circuit of claim 1, wherein the capacitor is a first capacitor, and the circuit further comprises:
an amplifier having first and second amplifier inputs and an amplifier output;
a third switch coupled between the temperature output terminal and the first amplifier input; and
a second capacitor coupled between the first amplifier input and the ground terminal.

3. The circuit of claim 2, further comprising:
a fourth switch coupled between the first amplifier input and a first reference voltage terminal, the first reference voltage terminal providing a first reference voltage; and
a fifth switch coupled between the first amplifier input and a second reference voltage terminal, the second reference voltage terminal providing a second reference voltage.

4. The circuit of claim 3, further comprising a latch circuit coupled between the amplifier output and a fault output terminal, the fault output terminal providing a fault signal.

5. The circuit of claim 3, further comprising a sixth switch coupled between the first current source and the diode input terminal, wherein the sixth switch and the first switch close alternately to provide either the first current or the second current to the diode input terminal.

6. The circuit of claim 5, wherein the sixth switch is closed for a first period of a cycle, and the first switch is closed for a second period of the cycle, and the first period is longer than the second period.

7. The circuit of claim 6, wherein the first period is at least twice as long as the second period of the cycle.

8. The circuit of claim 5, wherein the second switch and the sixth switch open and close synchronously.

9. The circuit of claim 4, wherein the fourth switch and the fifth switch are each controlled by the fault signal.

10. The circuit of claim 9, wherein the fourth switch and the fifth switch are in opposite positions.

11. The circuit of claim 3, wherein the first reference voltage and the second reference voltage represent first and second temperature limits, respectively.

12. The circuit of claim 11, wherein the first reference voltage is higher than the second reference voltage.

13. A method for sensing a temperature of a component, the method comprising:
providing a first current to a diode input terminal by closing a first switch that is coupled between a first current source and the diode input terminal;
providing a second current to the diode input terminal by opening the first switch and closing a second switch that is coupled between a second current source and the diode input terminal;
opening and closing a third switch synchronously with the opening and closing of the first switch, the third switch coupled between a temperature output terminal and a ground terminal;
coupling a capacitor between the diode input terminal and the temperature output terminal; and
providing a voltage signal at the temperature output terminal that is indicative of a temperature of the component.

14. The method of claim 13, wherein the voltage signal at the temperature output terminal is a difference in voltage across the component with the first current provided to it, and with the second current provided to it.

15. The method of claim 13, wherein the component is a diode.

16. The method of claim 13, wherein the component is a transistor.

17. The method of claim 13, further comprising:
comparing the voltage signal at the temperature output terminal to a first reference voltage; and
asserting a fault indication signal responsive to the voltage signal at the temperature output terminal having a higher voltage than the first reference voltage.

18. The method of claim 17, wherein after asserted, the fault indication signal remains asserted until the voltage signal at the temperature output terminal is lower in voltage than a second reference voltage, the second reference voltage being lower in voltage than the first reference voltage.

19. The method of claim 18, wherein the voltage signal at the temperature output terminal is compared to either the first reference voltage or the second reference voltage, depending on a value of the fault indication signal.

20. The method of claim 17, further comprising turning off the component responsive to the fault indication signal being asserted.
